(19) United States
(12) Patent Application Publication
(10) Pub. No.: US 2026/0226987 A1
(43) Pub. Date: Aug. 6, 2026

(54) VALVE SEAT ASSEMBLIES, VALVE ASSEMBLIES, AND FLUID ENDS FOR HIGH POWER PUMPS AND RELATED METHODS

(71) Applicant: Vulcan Industrial Holdings, LLC, Houston, TX (US)

(72) Inventors: Akhil Alex, Houston, TX (US); Richard David Peer, Houston, TX (US); Kyle Matthew Ellisor, Houston, TX (US); Steven Zachary Newberg, Houston, TX (US)

(21) Appl. No.: 19/419,905

(22) Filed: Dec. 15, 2025

Related U.S. Application Data
(60) Provisional application No. 63/754,275, filed on Feb. 5, 2025.

(51) Int. Cl. F16K 1/42; F04B 53/10

(52) U.S. Cl. CPC F16K 1/425; F04B 53/1087

(57) ABSTRACT

Valve seat assemblies and related assemblies, systems, and methods for high-power pumps may enhance the reliability of a valve seat and may include a seat carrier having a carrier body defining a carrier passage and a seat carrier recess having a recess wall dimension. The valve seat assembly further may include a seat insert positioned in the seat carrier recess. The seat insert may include an insert body defining an insert passage and having an insert outer wall dimension. The seat carrier may include a first material, and the seat insert may include a second material harder than the first material. The insert outer wall dimension may be greater than the recess wall dimension, thereby to provide an interference fit between the seat insert and the seat carrier recess, such that the seat carrier recess compresses the seat insert and extends a service life of the seat insert.

### CROSS-REFERENCE TO RELATED APPLICATIONS

This application claims priority to, and the benefit of U.S. Provisional Application No. 63/754,275, filed Feb. 5, 2025, titled “VALVE SEAT ASSEMBLIES, VALVE ASSEMBLIES, AND FLUID ENDS FOR HIGH POWER PUMPS AND RELATED METHODS,” the disclosure of which is incorporated herein by reference in its entirety.

### TECHNICAL FIELD

The present disclosure relates to valve seat assemblies and related assemblies, systems, and methods and, more particularly, to valve seat assemblies and related assemblies, systems, and methods for high-power pumps.

### BACKGROUND

Pumps may be used to transfer fluid having a first pressure from one location to another location at a second pressure greater than the first pressure. Pumps often include valves to control the flow of fluid into, through, and from a pump chamber of the pump. For example, a reciprocating plunger pump may include a first one-way valve or check-valve to allow fluid to be drawn into the pump and a second one-way valve or check-valve to permit the discharge of the fluid drawn into the pump while the first valve is closed. For example, the first valve may open to allow fluid to be drawn into the pump while the second valve is closed, and thereafter the first valve may close while the second valve is open while a plunger in the pump increases the pressure of the fluid in the pump chamber and forces the fluid through the second valve to pump the fluid.

An example of a high-power pump may be used, for example, to pump fracturing fluid at high pressures and high flow rates during a hydraulic fracturing operation. For example, a hydraulic fracturing operation involves pumping a fracturing fluid at high flow rates and high pressures sufficient to fracture a reservoir formation to allow hydrocarbons to more easily flow from the formation toward a wellbore for production. Such high flow rates and high pressures may result in significant wear to components associated with the fluid flow, such as the pumps used to pump the fracturing fluid. In addition, the fracturing fluid may contain substances, for example, proppants and fluids, having abrasive and corrosive characteristics, and thus, components associated with the fracturing operation may exhibit high wear rates or high failure rates. As a result, components associated with pumps, such as valves, may be particularly susceptible high wear rates and failures, thereby requiring replacement. For example, it is not uncommon to replace valves relatively frequently during the service life of a high-power pump, such as a pump used for a hydraulic fracturing operation, which may result in relatively high maintenance and service costs over the service life of the high-power pump.

For at least these reasons, Applicant has recognized that it may be desirable to provide valve seat assemblies and related assemblies, systems, and methods, resulting in relatively increased economic efficiencies associated with the reliability of valve seat assemblies of high-power pumps. At least some examples described herein may address one or more of the above-noted potential issues, as well as possibly others.

### SUMMARY

As referenced above, it may be desirable to provide valve seat assemblies and related assemblies, systems, and methods, resulting in relatively increased economic efficiencies associated with the reliability of valve seat assemblies of high-power pumps, such as, for example, valve seat assemblies used in the oil and gas industry, where the operating conditions and fluids may present a particularly harsh environment. In some embodiments, the valve seat assemblies presented herein may have a relatively enhanced reliability, resulting in less frequent service and replacement. For example, in some embodiments, a valve seat assembly may include a seat carrier and a seat insert at least partially positioned in a recess of the seat carrier. The seat insert may include a relatively harder or more wear-resistant material than the material forming the seat carrier. In some embodiments, the seat carrier may compress the seat insert, for example, radially inward, thereby to extend the service life of the valve seat assembly. In some embodiments, the valve seat assemblies may be connected to a fluid end of a high-power pump, for example, without being pressed into a tapered bore in a fluid end block, resulting in relatively easier assembly, maintenance, and/or replacement of the valve seat assemblies. This, in turn, may result in economic efficiencies associated with, for example, manufacturing, installation, service, and/or replacement of the valve seat assemblies. In some embodiments, the valve seat assemblies may provide a more wear-resistant strike face, presenting a relatively larger hardened surface against which a corresponding reciprocating valve member and associated valve seal may contact, resulting in greater wear-resistance of the valve seat assemblies.

According to some embodiments, a valve seat assembly to enhance reliability of a valve seat for a high-power pump may include a seat carrier having a carrier body at least partially defining a carrier passage and comprising a first material having a first material hardness. The carrier body may at least partially define a seat carrier recess, and the seat carrier recess may at least partially define a recess wall dimension. The valve seat assembly further may include a seat insert positioned in the seat carrier recess. The seat insert may include an insert body comprising carbide having a second material hardness greater than the first material hardness. The insert body may at least partially define (a) an insert passage and (b) an insert outer wall dimension. The insert outer wall dimension may be greater than the recess wall dimension, thereby to provide an interference fit between the seat insert and the seat carrier recess, such that the seat carrier recess compresses the seat insert and extends a service life of the seat insert.

According to some embodiments, a valve assembly for a high-power pump may include a suction valve including a valve seat assembly according to any of the valve seat assemblies described herein, and/or a discharge valve including a valve seat assembly according to any of the valve seat assemblies described herein. According to some embodiments, a fluid end for a high-power pump may include a valve seat assembly according to any of the valve seat assemblies described herein.

According to some embodiments, a valve assembly to enhance reliability of a valve seat assembly for a high-power pump may include a valve member positioned to reciprocate, relative to a fluid passage of the high-power pump, between a closed position preventing fluid flow through the fluid passage and an open position allowing fluid flow through the fluid passage. The valve assembly further may include a biasing member connected to the valve member, and the biasing member may be positioned to bias the valve member in the closed position or the open position. The valve assembly also may include a valve seat assembly comprising a seat carrier associated with the valve member, and the seat carrier may include a carrier body at least partially defining a carrier passage and comprising a first material having a first material hardness. The carrier body may at least partially define a seat carrier recess, and the seat carrier recess may at least partially define a recess wall dimension. The valve seat assembly further may include a seat insert positioned in the seat carrier recess, such that the valve member contacts the seat insert in the closed position and is spaced from the seat insert in the open position. The seat insert may include an insert body comprising a second material having a material hardness greater than the first material hardness. The insert body may at least partially define (a) an insert passage and (b) an insert outer wall dimension. The insert outer wall dimension may be greater than the recess wall dimension, thereby to provide an interference fit between the seat insert and the seat carrier recess, such that the seat carrier recess compresses the seat insert and extends a service life of the seat insert.

According to some embodiments, a fluid end to enhance reliability of a valve seat for a high-power pump may include a fluid end block at least partially defining a fluid passage, and a valve assembly connected to the fluid end block and positioned to at least partially control fluid flow through the fluid passage. The valve assembly may include a valve member positioned to reciprocate, relative to a fluid passage of the high-power pump, between a closed position preventing fluid flow through the fluid passage and an open position allowing fluid flow through the fluid passage. The valve assembly further may include a biasing member connected to the valve member, and the biasing member may be positioned to bias the valve member in the closed position or the open position. The valve assembly also may include a valve seat assembly including a seat carrier associated with the valve member, and the seat carrier may include a carrier body at least partially defining a carrier passage and comprising a first material having a first material hardness. The carrier body may at least partially define a seat carrier recess, and the seat carrier recess may at least partially define a recess wall dimension. The valve seat assembly further may include a seat insert positioned in the seat carrier recess, such that the valve member contacts the seat insert in the closed position and is spaced from the seat insert in the open position. The seat insert may include an insert body comprising a second material having a material hardness greater than the first material hardness. The insert body may at least partially define (a) an insert passage and (b) an insert outer wall dimension. The insert outer wall dimension may be greater than the recess wall dimension, thereby to provide an interference fit between the seat insert and the seat carrier recess, such that the seat carrier recess compresses the seat insert and extends a service life of the seat insert. The fluid end further may include a valve assembly retainer connected to the fluid end block and/or the valve assembly. The fluid end block and/or the valve assembly retainer may at least partially define a seat assembly recess, and the valve seat assembly may be at least partially positioned in the seat assembly recess.

According to some embodiments, a high-power pump may include a fluid end according to any of the fluid ends described herein.

According to some embodiments, a method to enhance reliability of a valve seat assembly for a high-power pump may include expanding a seat carrier recess in a seat carrier of the valve seat assembly to provide an expanded seat carrier recess. The method further may include positioning a seat insert of the valve seat assembly in the expanded seat carrier recess. The method also may include contracting the seat carrier recess around the seat insert, thereby to engage the seat insert via the seat carrier recess, such that the seat carrier recess compresses the seat insert and extends a service life of the seat insert.

According to some embodiments, a method to retain a valve seat assembly in a fluid end of a high-power pump, thereby to enhance reliability of the valve seat assembly, may include providing a seat assembly recess in a fluid end block and/or a valve assembly retainer, the seat assembly recess having a recess wall dimension. The method further may include positioning the valve seat assembly in the seat assembly recess, the valve seat assembly having an outer wall dimension less than the recess wall dimension. The method also may include connecting the valve assembly retainer to the fluid end block, thereby to retain the valve seat assembly relative to the fluid end block and the valve assembly retainer, so as to extend a service life of the valve seat assembly.

According to some embodiments, a valve seat assembly to enhance reliability of a valve seat for a high-power pump may include a seat carrier including a carrier body at least partially defining a carrier passage. The carrier passage may have a carrier passage axis and a carrier passage dimension. The carrier body may include a first material having a first material hardness, and the carrier body may define a carrier body cross-section including a recess wall extending substantially parallel to the carrier passage axis, the recess wall at least partially defining a recess wall dimension. The carrier body cross-section further may include a recess base extending from the recess wall and at least partially defining the carrier passage, the recess wall and the recess base at least partially defining a seat carrier recess. The valve seat assembly further may include a seat insert positioned in the seat carrier recess, and the seat insert may include an insert body comprising a second material having a material hardness greater than the first material hardness. The insert body may at least partially define (a) an insert passage having an insert passage dimension, (b) an insert passage axis substantially parallel to the carrier passage axis, and (c) an insert body cross-section including an insert base positioned in the seat carrier recess and contacting the recess base of the seat carrier. The insert body cross-section further may include a strike face opposite the insert base and positioned to be intermittently contacted by a reciprocating valve member. The insert body cross-section also may include an insert outer wall extending substantially parallel to the carrier passage axis and at least partially defining an insert outer wall dimension. The insert outer wall dimension may be greater than the recess wall dimension, thereby to provide an interference fit between the seat insert and the seat carrier recess, such that the seat carrier recess compresses the seat insert and extends a service life of the seat insert.

According to some embodiments, a valve assembly to enhance reliability of a valve seat assembly for a high-power pump may include a valve member positioned to reciprocate, relative to a fluid passage of the high-power pump, between a closed position preventing fluid flow through the fluid passage and an open position allowing fluid flow through the fluid passage. The valve assembly further may include a biasing member connected to the valve member, and the biasing member may be positioned to bias the valve member in the closed position or the open position. The valve assembly also may include a valve seat assembly including a seat carrier associated with the valve member, and the seat carrier may include a carrier body at least partially defining a carrier passage. The carrier passage may have a carrier passage axis and a carrier passage dimension. The carrier body may comprise a first material having a first material hardness. The carrier body may define a carrier body cross-section including a recess wall extending substantially parallel to the carrier passage axis, and the recess wall may at least partially define a recess wall dimension. The carrier body cross-section further may include a recess base extending from the recess wall and at least partially defining the carrier passage. The recess wall and the recess base may at least partially define a seat carrier recess. The valve seat assembly further may include a seat insert positioned in the seat carrier recess, such that the valve member contacts the seat insert in the closed position and is spaced from the seat insert in the open position. The seat insert may include an insert body comprising a second material having a material hardness greater than the first material hardness. The insert body may at least partially define (a) an insert passage having an insert passage dimension, (b) an insert passage axis substantially parallel to the carrier passage axis, and (c) an insert body cross-section including: (i) an insert base positioned in the seat carrier recess and contacting the recess base of the seat carrier, (ii) a strike face opposite the insert base and positioned to be intermittently contacted by the valve member when in the closed position, and (iii) an insert outer wall extending substantially parallel to the carrier passage axis and at least partially defining an insert outer wall dimension. The insert outer wall dimension may be greater than the recess wall dimension, thereby to provide an interference fit between the seat insert and the seat carrier recess, such that the seat carrier recess compresses the seat insert and extends a service life of the seat insert.

According to some embodiments, a fluid end to enhance reliability of a valve seat for a high-power pump may include a fluid end block at least partially defining a fluid passage, and a valve assembly connected to the fluid end block and positioned to at least partially control fluid flow through the fluid passage. The valve assembly may include a valve member positioned to reciprocate, relative to a fluid passage of the high-power pump, between a closed position preventing fluid flow through the fluid passage and an open position allowing fluid flow through the fluid passage. The valve assembly further may include a biasing member connected to the valve member, and the biasing member may be positioned to bias the valve member in the closed position or the open position. The valve assembly also may include a valve seat assembly including a seat carrier associated with the valve member, and the seat carrier may include a carrier body at least partially defining a carrier passage. The carrier passage may have a carrier passage axis and a carrier passage dimension. The carrier body may comprise a first material having a first material hardness, and the carrier body may define a carrier body cross-section including a recess wall extending substantially parallel to the carrier passage axis, the recess wall at least partially defining a recess wall dimension. The carrier body cross-section further may include a recess base extending from the recess wall and at least partially defining the carrier passage. The recess wall and the recess base may at least partially define a seat carrier recess. The valve seat assembly further may include a seat insert positioned in the seat carrier recess, such that the valve member contacts the seat insert in the closed position and is spaced from the seat insert in the open position. The seat insert may include an insert body comprising a second material having a material hardness greater than the first material hardness. The insert body may at least partially define (a) an insert passage having an insert passage dimension, (b) an insert passage axis substantially parallel to the carrier passage axis, and (c) an insert body cross-section including: (i) an insert base positioned in the seat carrier recess and contacting the recess base of the seat carrier, (ii) a strike face opposite the insert base and positioned to be intermittently contacted by the valve member when in the closed position, and (iii) insert outer wall extending substantially parallel to the carrier passage axis and at least partially defining an insert outer wall dimension. The insert outer wall dimension may be greater than the recess wall dimension, thereby to provide an interference fit between the seat insert and the seat carrier recess, such that the seat carrier recess compresses the seat insert and extends a service life of the seat insert. The fluid end also may include a valve assembly retainer connected to the fluid end block and/or the valve assembly. The fluid end block and/or the valve assembly retainer may at least partially define a seat assembly recess, and the valve seat assembly may be at least partially positioned in the seat assembly recess.

Still other aspects and advantages of these exemplary embodiments and other embodiments, are discussed in detail herein. Moreover, it is to be understood that both the foregoing information and the following detailed description provide merely illustrative examples of various aspects and embodiments and are intended to provide an overview or framework for understanding the nature and character of the claimed aspects and embodiments. Accordingly, these and other objects, along with advantages and features of the present disclosure, will become apparent through reference to the following description and the accompanying drawings. Furthermore, it is to be understood that the features of the various embodiments described herein are not mutually exclusive and may exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain principles of the embodiments discussed herein. No attempt is made to show structural details of this disclosure in more detail than may be necessary for a fundamental understanding of the embodiments discussed herein and the various ways in which they may be practiced. According to common practice, the various features of the drawings discussed below are not necessarily drawn to scale. Dimensions of various features and elements in the drawings may be expanded or reduced to more clearly illustrate embodiments of the disclosure.

FIG. 1 is a schematic perspective view of an example high-power pump, including an example fluid end, according to embodiments of the disclosure.

FIG. 2 is a schematic perspective section view of an example fluid end consistent with FIG. 1 as viewed along section A-A, according to embodiments of the disclosure.

FIG. 3 is a schematic front end section view of an example fluid end consistent with FIG. 1 as viewed along section A-A, according to embodiments of the disclosure.

FIG. 4A is a partial schematic front end section view of an example fluid end consistent with FIG. 1 as viewed along section A-A, showing an example suction valve assembly, including an associated example valve seat assembly, according to embodiments of the disclosure.

FIG. 4B is a partial schematic front end section view of an example suction valve assembly consistent with FIG. 4A, including the associated example valve seat assembly, according to embodiments of the disclosure.

FIG. 5A is a partial schematic front end section view of an example fluid end consistent with FIG. 1 as viewed along section A-A, showing an example discharge valve assembly, including an associated example valve seat assembly, according to embodiments of the disclosure.

FIG. 5B is a partial schematic front end section view of an example discharge valve assembly consistent with FIG. 5A, including the associated example valve seat assembly, according to embodiments of the disclosure.

FIG. 6A is a schematic perspective view of an example valve seat assembly, according to embodiments of the disclosure.

FIG. 6B is a schematic section view of the example valve seat assembly shown in FIG. 6A, as viewed along section 6B-6B, according to embodiments of the disclosure.

FIG. 7A is a schematic perspective view of another example valve seat assembly, according to embodiments of the disclosure.

FIG. 7B is a schematic section view of the example valve seat assembly shown in FIG. 7A, as viewed along section 7B-7B, according to embodiments of the disclosure.

### DETAILED DESCRIPTION

The drawings include like numerals to indicate like parts throughout the several views, the following description is provided as an enabling teaching of exemplary embodiments, and those skilled in the relevant art will recognize that many changes may be made to the embodiments described. It also will be apparent that some of the desired benefits of the embodiments described may be obtained by selecting some of the features of the embodiments without utilizing other features. Accordingly, those skilled in the art will recognize that many modifications and adaptations to the embodiments described are possible and may even be desirable in certain circumstances. Thus, the following description is provided as illustrative of the principles of the embodiments and not in limitation thereof.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, in particular, to mean “including but not limited to,” unless otherwise stated. Thus, the use of such terms is meant to encompass the items listed thereafter, and equivalents thereof, as well as additional items. The transitional phrases “consisting of” and “consisting essentially of,” are closed or semi-closed transitional phrases, respectively, with respect to any claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish claim elements.

The present disclosure is generally directed to valve seat assemblies, and related assemblies, systems, and methods and, more particularly, to valve seat assemblies and related assemblies, systems, and methods for high-power pumps, such as, for example, valve seat assemblies used in the oil and gas industry, where the operating conditions and fluids may present a particularly harsh environment. Some valve seats may be formed of carbide, which provides a hard surface against which a valve member may contact, but Applicant has recognized that such valves seats, while hard, may still suffer from a number of potential drawbacks. For example, such valve seats may be relatively brittle, often suffering from sudden failure due to, for example, being press-fit into a tapered bore of a fluid end or housing, and/or from being subjected to repeated contact by a valve member. For example, a carbide portion of a valve seat may be pressed into a tapered bore of the fluid end or housing, and the tapered bore may subject the carbide portion to unevenly distributed loads. As a result, the carbide portion may become separated from the tapered bore or may crack due to uneven compressive loading. In addition, for some valve seats positioned in relatively softer materials, such as steel, the service life of the valve seat may be limited by the relatively limited service life of the receiving steel portion due high wear rates associated with the flow of abrasive and/or corrosive fluids often encountered in, for example, the oil and gas industry.

In some embodiments, the valve seat assemblies presented herein may have a relatively enhanced reliability, resulting in less frequent service and replacement. For example, in some embodiments, a valve seat assembly may include a seat carrier and a seat insert at least partially positioned in a recess of the seat carrier. The seat insert may include a relatively harder or more wear-resistant material than the material forming the seat carrier. In some embodiments, the seat carrier may compress the seat insert, for example, radially inward, thereby to extend the service life of the valve seat assembly. For example, the seat carrier may compress the outer circumference of the seat insert in a relatively uniform radially inward-directed manner. In some embodiments, the valve seat assemblies may be connected to a fluid end of a high-power pump, for example, without being pressed into a tapered bore in a fluid end block of the pump. This connection may result in relatively easier assembly, maintenance, and/or replacement of the valve seat assemblies. This, in turn, may result in economic efficiencies associated with, for example, manufacturing, installation, service, and/or replacement of the valve seat assemblies. In some embodiments, the valve seat assemblies may provide a more wear-resistant strike face, presenting a relatively larger hardened surface against which a corresponding reciprocating valve member and associated valve seal may impact, resulting in greater reliability and wear-resistance of the valve seat assemblies.

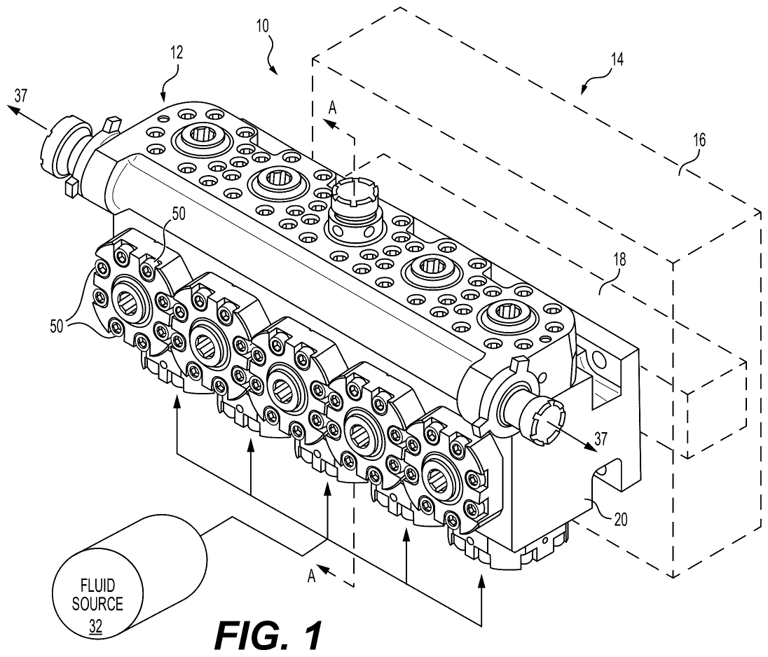

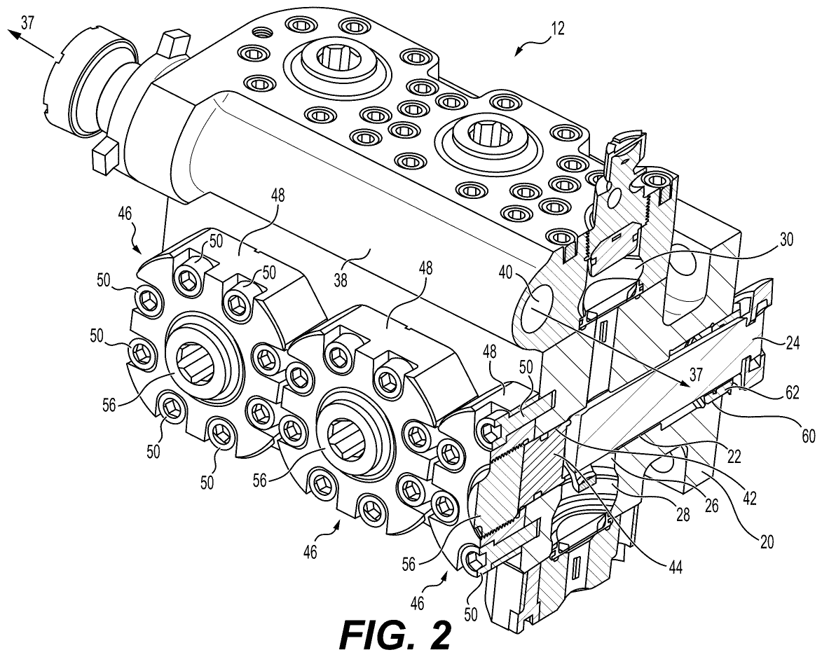

For example, FIG. 1 is a schematic perspective view of an example pump 10, including an example fluid end 12, and a schematic depiction of an example power end 14, according to embodiments of the disclosure. FIG. 2 is a schematic perspective section view of an example fluid end 12 consistent with FIG. 1 as viewed along section A-A of FIG. 1, according to embodiments of the disclosure. The pump 10 may be any high-power pump, high-pressure pump, reciprocating pump, and/or high-flow rate pump suitable for pumping solids, semi-solids, slurries, liquids, fluids, or combinations thereof. In some embodiments, the pump 10 may be, for example, a hydraulic fracturing pump for pumping hydraulic fracturing fluid. Although embodiments of the pump 10 are described herein as being a “hydraulic fracturing pump” for pumping hydraulic fracturing fluid for the purpose of discussion, the pump 10 may be any other type of pump, such as, for example, any type of high-power pump, high-pressure pump, reciprocating pump, and/or high-flow rate pump suitable for pumping solids, semi-solids, slurries, liquids, fluids, or combinations thereof. In some embodiments, the pump 10 may be, for example, a hydraulic fracturing pump for pumping solids, semi-solids, slurries, liquids, fluids, or combinations thereof, such as hydraulic fracturing fluid.

For example, a reciprocating plunger pump may be used to pump a fracturing fluid at high flow rates and high pressures sufficient to fracture a reservoir formation to allow hydrocarbons to more easily flow from the formation toward a wellbore for production. A hydraulic fracturing operation may include as many as six or more hydraulic fracturing units, and each of the hydraulic fracturing units may include a prime mover, such as an electric motor or internal combustion engine, either directly connected, or connected via a transmission, to the reciprocating plunger pump to supply power to drive the reciprocating plunger pump to pump the fracturing fluid into the formation to stimulate production of the well. For example, typical flow rates for a hydraulic fracturing operation may range from about 1,500 to about 4,000 gallons per minute, and typical pressures may range from about 7,500 to about 15,000 pounds per square inch. Although many examples discussed in this disclosure are explained in relation to hydraulic fracturing pumps, such as reciprocating plunger pumps for pumping fracturing fluid and related methods, other flow control-related and/or pumping-related operations, components, and methods are contemplated.

As shown in FIG. 1, the example pump 10 may be a reciprocating plunger pump and may include the fluid end 12 and the power end 14. The power end 14 may include, for example, a housing 16 for power transmission components 18, such as a crankshaft, bearings supporting the crankshaft in the housing, crossheads, reduction gears, pony rods, connecting rods and/or plungers connected to the pony rods or connecting rods. A prime mover, such as an electric motor and/or an internal combustion engine, may be connected to the power transmission components 18, thereby to drive the power transmission components 18 during operation of the pump 10.

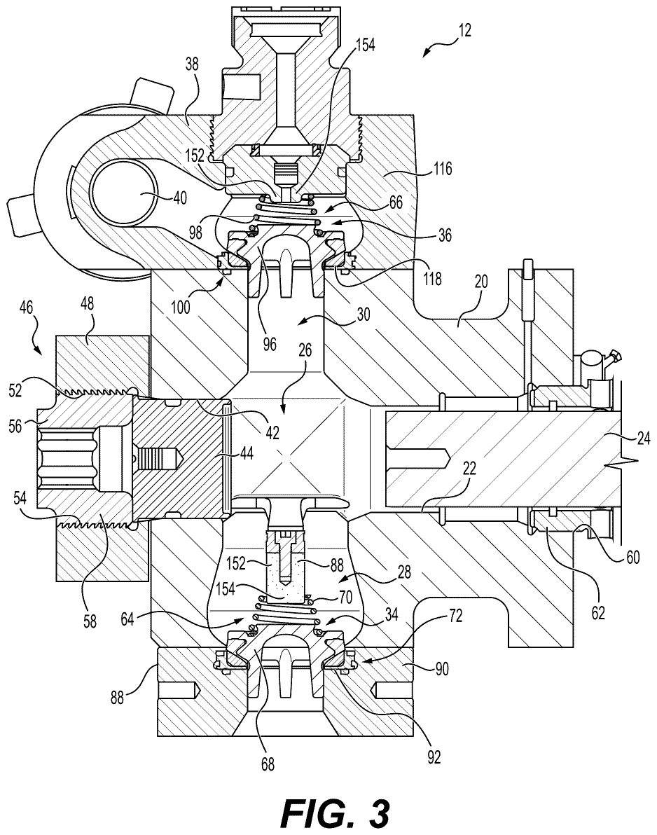

FIG. 3 is a schematic front end section view of an example fluid end 12 consistent with FIG. 1 as viewed along section A-A of FIG. 1, according to embodiments of the disclosure. As shown in FIGS. 2 and 3, the fluid end 12 may include, for example, a fluid end block 20 including one or more cylinders 22 in which respective plungers 24 reciprocate, one or more chambers 26 receiving fluid, one or more suction ports 28 for drawing fluid into the one or more chambers 26, and one or more discharge ports 30 for discharging fluid from the one or more chambers 26 at a higher pressure. For example, as each plunger 24, moved via operation of the power transmission components 18 of the power end 14, at least partially retracts into a respective cylinder 22, fluid is drawn from a fluid source 32 into the chamber 26 of the fluid end 12 via the suction port 28 in the fluid end block 20 while a suction valve 34 is open and a discharge valve 36 is closed. As each plunger 24 reverses direction and moves back toward the chamber 26, moved via operation of the power transmission components 18, pressurized fluid 37 (e.g., fluid at a higher pressure than fluid received from the fluid source 32) is discharged from the fluid end 12 via the discharge port 30 in the fluid end block 20 while the discharge valve 36 is open and the suction valve 34 is closed. In some embodiments, the pump 10 may further include a discharge manifold 38 having a discharge passage 40, and the discharge valve 36, when open, may allow the pressurized fluid 37 to be discharged from the pump 10 via the discharge manifold 38 and discharge passage 40 for downstream use, for example, as part of a hydraulic fracturing operation or other operation. The suction valve 34 and/or the discharge valve 36 may be one-way valves or check-valves, allowing fluid to flow only in a single direction, either into the chamber 26 of the fluid end block 20 via the suction valve 34, or from the chamber 26 of the fluid end block 20 via the discharge valve 36. In this example manner, the fluid end 12 draws fluid from the fluid source 32 into the fluid end block 20 at a first pressure and discharges the fluid from the fluid end 12 at a higher pressure. In some pump embodiments, the fluid end 12 may include multiple (e.g., two, three, four, or five) sets of suction ports, cylinders, plungers, and/or discharge ports to pump fluid at high pressures and/or high flow rates.

As shown in FIGS. 1 and 2, according to some embodiments, the fluid end 12 may include an access port 42 providing access to the chamber 26, for example, for use during assembly and/or maintenance of the fluid end 12. The access port 42 may be selectively closed via a cover 44 positioned in the access port 42. In some embodiments, the access port 42 may be defined in the fluid end block 20 by a circular aperture having an interior face having a substantially cylindrical configuration, for example, as shown in FIG. 2. In some embodiments, the cover 44 may have a substantially circular cross-section and may have a substantially cylindrical configuration sized and shaped to fit within the interior face of the access port 42, for example, as shown in FIG. 2. In some embodiments, the cover 44 may be sized and shaped to fit snugly (e.g., in a substantially sealed manner) within the access port 42. In some embodiments, a retainer assembly 46 may be used to secure the cover 44 within the access port 42. As shown, in some embodiments, the retainer assembly 46 may include an outer housing 48 configured to be secured to an exterior surface of the fluid end block 20 adjacent the access port 42, for example, via one or more fasteners 50 (e.g., studs and nuts), as shown. The outer housing 48 may define a receiver aperture 52 provided with internal threads 54. The retainer assembly 46 further may include a retainer 56, which may include a substantially cylindrical body having external threads 58 configured to threadedly engage the internal threads 54 of the outer housing 48. In some embodiments, the retainer 56 may be threaded into the outer housing 48 and contact an exterior end of the cover 44, thereby to secure the cover 44 in the access port 42.

As shown in FIGS. 2 and 3, in some embodiments, the fluid end block 20 may include a plunger port 60 and a sleeve 62 positioned in the plunger port 60. The plunger port 60 and the sleeve 62 may be substantially cylindrical, with the plunger port 60 having a substantially circular cross-section and the sleeve 62 having a substantially cylindrical outer surface positioned in the plunger port 60. The sleeve 62 may be configured to at least partially receive therein the plunger 24 as the plunger 24 reciprocates, thereby to draw fluid into the chamber 26 at a first pressure via the suction port 28 during movement of the plunger 24 in a first direction and discharge the fluid from the chamber 26 at a second pressure greater than the first pressure via the discharge port 30 during movement of the plunger 24 in a second direction opposite the first direction.

As shown in FIG. 3, in some embodiments, the suction valve 34 may include a suction valve assembly 64, and the discharge valve 36 may include a discharge valve assembly 66. For example, the suction valve assembly 64 may be connected to the fluid end block 20 and positioned to at least partially control fluid flow through a fluid passage, for example, the suction port 28. The discharge valve assembly 66 may be connected to the fluid end block 20 and positioned to at least partially control fluid flow through a fluid passage, for example, the discharger port 30.

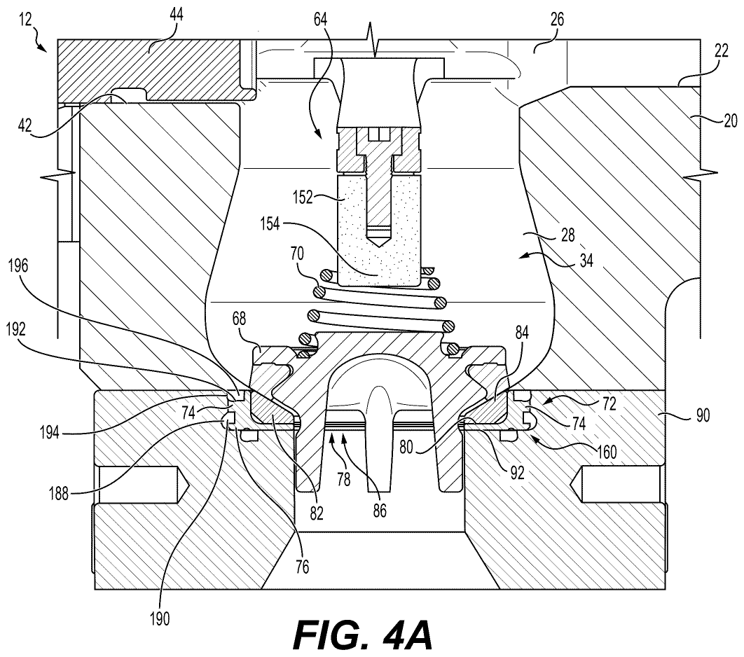

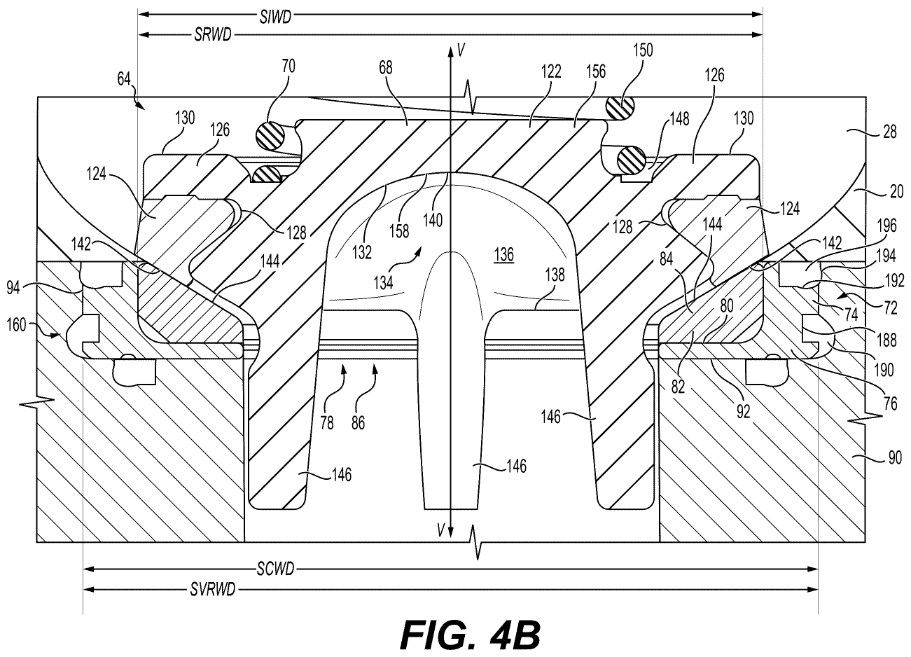

FIG. 4A is a partial schematic front end section view of an example fluid end 12 consistent with FIG. 1 as viewed along section A-A, showing an example suction valve assembly 64, according to embodiments of the disclosure. FIG. 4B is a partial schematic front end section view of an example suction valve assembly 64 consistent with FIG. 4A, according to embodiments of the disclosure.

In some embodiments, as shown in FIGS. 3, 4A, and 4B, for example, the suction valve assembly 64 may include a suction valve member 68 positioned to reciprocate, relative to the suction port 28, between a closed position preventing fluid flow through the suction port 28 and an open position allowing fluid flow through the suction port 28. The suction valve assembly 64 further may include a suction valve biasing member 70 connected to the suction valve member 68, and the suction valve biasing member 70 may be positioned to bias the suction valve member 68 in either the closed position or the open position (e.g., in the closed position).

As shown in FIGS. 3, 4A, and 4B, for example, in some embodiments, the suction valve assembly 64 further may include a suction valve seat assembly 72. For example, the suction valve seat assembly 72 may include a suction valve seat carrier 74 associated with the suction valve member 68, and the suction valve seat carrier 74 may have a suction valve carrier body 76 at least partially defining a suction valve carrier passage 78. According to some embodiments, the suction valve carrier body 76 may at least partially define a suction valve seat carrier recess 80, which may at least partially define a suction valve recess wall dimension SRWD, for example, a radius and/or a diameter, as shown in FIG. 4B. As shown in FIG. 4A, for example, the suction valve seat assembly 72 further may include a suction valve seat insert 82 at least partially positioned in the suction valve seat carrier recess 80, such that the suction valve member 68 contacts the suction valve seat insert 82 in the closed position (e.g., as shown in FIGS. 4A and 4B) and is spaced from the suction valve seat insert 82 in the open position, with the suction valve seat insert 82 including a suction valve insert body 84 at least partially defining a suction valve insert passage 86. As shown in FIG. 4B, the suction valve insert body 84 may at least partially define a suction valve insert outer wall dimension SIWD, for example, a radius and/or a diameter. In some embodiments, the suction valve carrier body 76 may comprise, or be formed of, a first material having a first material hardness, and the suction valve insert body 84 may comprise, or be formed of, a second material having a material hardness greater than the first material hardness.

In some embodiments, as shown in FIG. 4B, the suction valve insert outer wall dimension SIWD may be greater than the suction valve recess wall dimension SRWD, thereby to provide an interference fit between the suction valve seat insert 82 and the suction valve seat carrier recess 80, such that the suction valve seat carrier recess 80 compresses the suction valve seat insert 82, thereby to extend the service life of the suction valve seat insert 82. Applicant has recognized that valve seats formed of hard materials to resist wear during operation of a fluid end in which the valve seats are installed may often be brittle and suffer sudden catastrophic fracture and failure, necessitating replacement at relatively short intervals. For example, some such valve seats may be formed solely from hard materials, such as, for example, solid carbide. Solid carbide valve seats, while more resistant to wear from abrasive and/or corrosive fluids and valve member contact, may often be installed in a tapered valve seat-receiving aperture of the fluid end, and installation and removal of solid carbide valve seats may result in fracture of the valve seat due, for example, to high installation and removal forces often necessary to install and remove the valve seats, such high installation and removal forces provided by hydraulically-powered tools. In addition, solid carbide valve seats, which are relatively brittle, are often prone to fracture or failure during pump operation via the repeated contact with a corresponding valve member. In addition, forming the valve seat solely from carbide may results in inefficiencies, for example, as compared to forming valve seats from steel and alloy steel.

In order to offset at least some of the above-noted issues with carbide valve seats, carbide portions of the valve seat may be combined with less brittle and or more efficient materials, such as steel. Applicant has recognized that such valve seats also may suffer from several potential issues. For example, carbide portions of such valve seats may become loose or separated from the steel portions, for example, due to uneven compressive loads on the carbide portion via the steel portion. In addition, the steel portion, being relatively softer than the carbide portion, may suffer from excessive wear due to abrasive and/or corrosive fluids flowing through the associated valve, which may result in an undesirably limited service life of the valve seat.

As described herein, in at least some embodiments, the suction valve seat assembly 72 may include a suction valve seat carrier 74 at least partially defining a suction valve seat carrier recess 80, and a suction valve seat insert 82 at least partially positioned in the suction valve seat carrier recess 80. As described herein, in some embodiments, the suction valve seat carrier 74 may comprise, or be formed of, a relatively softer material, such as, for example, steel and/or alloy steel, and the suction valve seat insert 82 may comprise, or be formed of, one or more relatively harder materials, such as, for example, a carbide or a carbide-containing material, thereby to provide a more wear-resistant strike face. In at least some embodiments, the interference fit between the suction valve seat insert 82 and the suction valve seat carrier recess 80 may result in radially inward compressive forces on the suction valve seat insert 82, via the suction valve seat carrier recess 80, which, in turn, may extend the service life of the suction valve seat insert 82. For example, the radially inward forces may be substantially uniform circumferentially around the suction valve seat insert 82. This may reduce the wear rate, or substantially prevent degradation of, the suction valve seat insert 82. In some embodiments, this may reduce the likelihood, delay, or substantially prevent, the suction valve seat insert 82 from fracturing, for example, during operation of the fluid end 12. For example, when the suction valve seat insert 82 comprises, or is formed of, a hard material, such as a carbide or a carbide-containing material, the compressive forces may function to reduce the likelihood, delay, or substantially prevent, the suction valve seat insert 82 from fracturing. This contrasts with, for example, carbide valve seats positioned in a tapered aperture, which may result in relatively uneven compressive forces being exerted on the valve seat, which may lead to premature fracture or failure. In addition, such carbide valve seats may separate from the aperture in which they are positioned due to uneven compressive forces, which may often result in failure of the valve seat.

As shown in FIGS. 3 and 4A, the fluid end 12 may further include a suction valve assembly retainer 88 connected to the fluid end block 20 and/or the suction valve assembly 64. For example, in some embodiments, the suction valve assembly retainer 88 may include a suction flange 90 connected to the fluid end block 20 and/or the suction valve assembly 64, for example, via one or more fasteners, such as bolts, nuts, and/or studs. For example, the fluid end block 20 and/or the suction flange 90 may at least partially define a suction valve seat assembly recess 92 (FIGS. 4A and 4B), and the suction valve seat assembly 72 may be at least partially positioned in the suction valve seat assembly recess 92. For example, the one or more fasteners may connect the suction flange 90 to the fluid end block 20, thereby retaining the suction valve seat assembly 72 in position relative to the suction port 28 of the fluid end block 20, for example, as shown in FIGS. 3, 4A, and 4B.

In some embodiments, the suction valve seat assembly recess 92 may be at least partially defined by the suction flange 90. For example, as shown in FIG. 4B, the suction valve carrier body 76 may at least partially define a suction valve outer carrier wall 94 at least partially positioned in the suction valve seat assembly recess 92. The suction valve outer carrier wall 94 may have a suction valve carrier outer wall dimension SCWD, the suction valve seat assembly recess 92 may have a suction valve seat assembly recess wall dimension SVRWD, and the suction valve assembly recess wall dimension SVRWD may be greater than the suction valve carrier outer wall dimension SCWD, for example, such that the fit between the suction valve seat assembly recess 92 and the suction valve outer carrier wall 94 lacks a press fit.

Applicant has recognized that valve seats formed of hard materials, such as carbide are often positioned in tapered apertures of a fluid end block, and that such arrangements may often result in several potential issues. For example, it may be difficult to accurately machine a tapered aperture into the fluid end block, often resulting in manufacturing inefficiencies. In addition, installing and/or removing such valve seats relative to a tapered aperture may require the use of powerful tools, such as hydraulic presses, the use of which may be challenging, time-consuming, and may provide less than satisfactory results, particularly on-site. In some instances, the use of powerful installation/removal tools may result in damage to the valve seat, particularly valve seats comprising or formed of hard materials, such as carbide, which may be relatively brittle.

In some embodiments, the suction valve carrier body 76 may be at least partially positioned in the suction valve seat assembly recess 92, which may not include a tapered wall. For example, the suction valve outer carrier wall 94 may be at least partially positioned in the suction valve seat assembly recess 92, and the suction valve outer carrier wall 94 and the suction valve seat assembly recess 92 may include mutually facing substantially cylindrical walls (e.g., substantially non-tapered walls and/or non-frustoconical surfaces). For example, in some embodiments, the suction valve assembly retainer 88 may be connected to the fluid end block 20 and/or the suction valve assembly 64, for example, via one or more fasteners, such as bolts, nuts, and/or studs, and such connection may prevent the need for a tapered engagement between the suction valve seat assembly 72 and the fluid end block 20, thus potentially eliminating one or more of the above-noted potential issues associated with valve seats that are positioned in tapered apertures. For example, in some embodiments, no tapered apertures are machined into the fluid end block 20 for receipt of the suction valve seat assembly 72, thus simplifying manufacturing and resulting in potential manufacturing efficiencies. Because there is no tapered fit, powerful tools for installing and/or removing the suction valve seat assembly 72 may be unnecessary, thereby resulting in potential manufacturing and/or service efficiencies. This further may result in a reduced likelihood or prevention of damage to the suction valve seat assembly 72 during installation and/or removal.

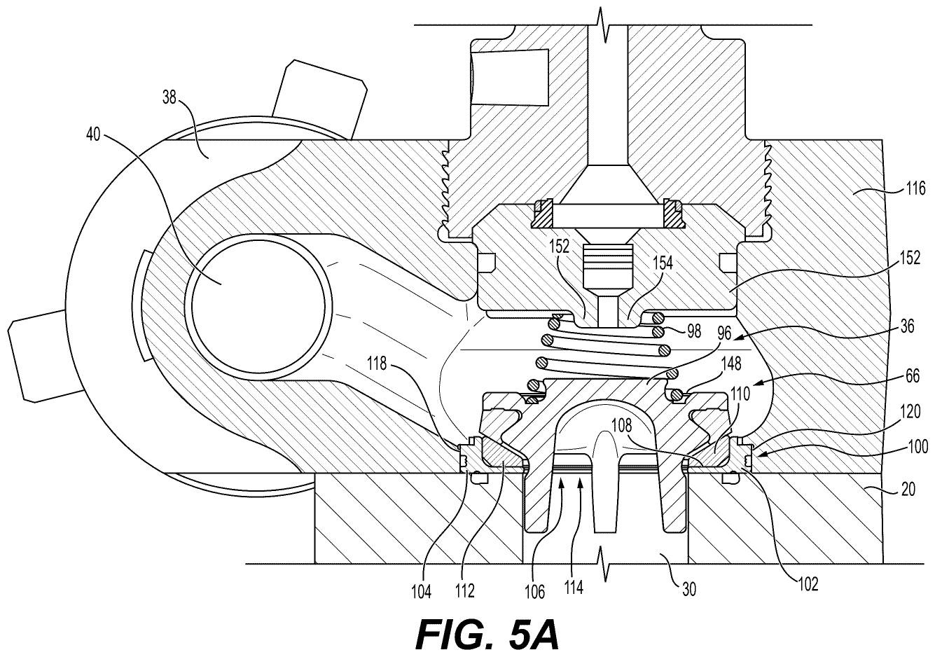

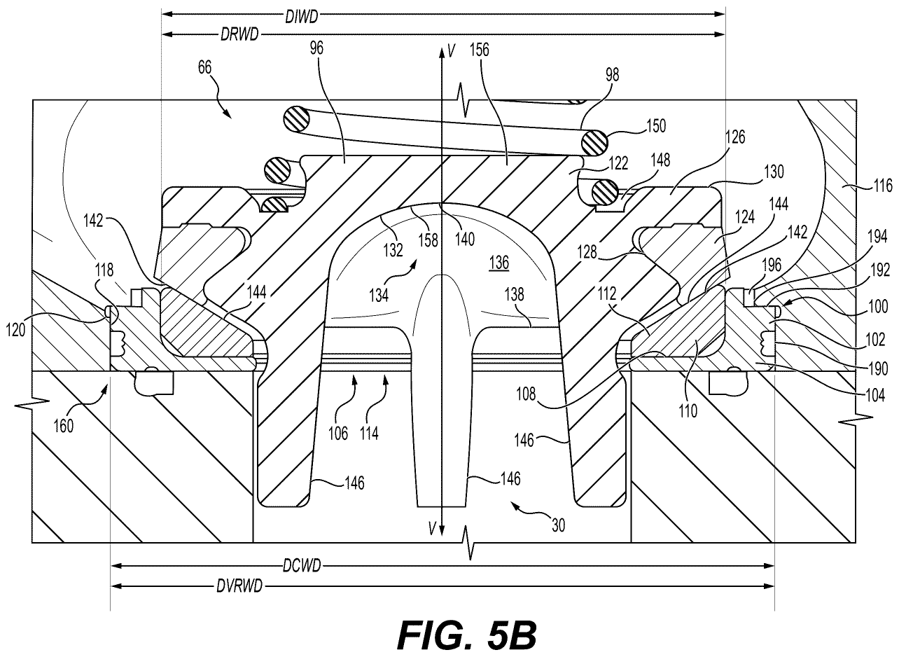

FIG. 5A is a partial schematic front end section view of an example fluid end 12 consistent with FIG. 1 as viewed along section A-A, showing an example discharge valve assembly 66, according to embodiments of the disclosure. FIG. 5B is a partial schematic front end section view of an example discharge valve assembly 66 consistent with FIG. 5A, according to embodiments of the disclosure.

In some embodiments, as shown in FIGS. 3, 5A, and 5B, for example, the discharge valve assembly 66 may include a discharge valve member 96 positioned to reciprocate, relative to the discharge port 30, between a closed position preventing fluid flow through the discharge port 30 and an open position allowing fluid flow through the discharge port 30. The discharge valve assembly 66 further may include a discharge valve biasing member 98 connected to the discharge valve member 96, and the discharge valve biasing member 98 may be positioned to bias the discharge valve member 96 in either the closed position or the open position (e.g., in the closed position).

As shown in FIGS. 3, 5A, and 5B, for example, in some embodiments, the discharge valve assembly 66 further may include a discharge valve seat assembly 100. For example, the discharge valve seat assembly 100 may include a discharge valve seat carrier 102 associated with the discharge valve member 96, and the discharge valve seat carrier 102 may have a discharge valve carrier body 104 at least partially defining a discharge valve carrier passage 106. According to some embodiments, the discharge valve carrier body 104 may at least partially define a discharge valve seat carrier recess 108, which may at least partially define a discharge valve recess wall dimension DRWD, for example, a radius and/or a diameter. As shown in FIGS. 5A and 5B, for example, the discharge valve seat assembly 100 further may include a discharge valve seat insert 110 at least partially positioned in the discharge valve seat carrier recess 108, such that the discharge valve member 96 contacts the discharge valve seat insert 110 in the closed position and is spaced from the discharge valve seat insert 110 in the open position, with the discharge valve seat insert 110 including a discharge valve insert body 112 at least partially defining a discharge valve insert passage 114. The discharge valve insert body 112 may at least partially define a discharge valve insert outer wall dimension DIWD, for example, a radius and/or a diameter. In some embodiments, the discharge valve carrier body 104 may comprise, or be formed of, a first material having a first material hardness, and the discharge valve insert body 112 may include, or be formed of, a second material having a material hardness greater than the first material hardness.

In some embodiments, the discharge valve insert outer wall dimension DIWD may be greater than the discharge valve recess wall dimension DRWD, thereby to provide an interference fit between the discharge valve seat insert 110 and the discharge valve seat carrier recess 108, such that the discharge valve seat carrier recess 108 compresses the discharge valve seat insert 110, thereby to extend the service life of the discharge valve seat insert 110.

As described herein, in at least some embodiments, the discharge valve seat assembly 100 may include a discharge valve seat carrier 102 at least partially defining a discharge valve seat carrier recess 108, and a discharge valve seat insert 110 at least partially positioned in the discharge valve seat carrier recess 108. As described herein, in some embodiments, the discharge valve seat carrier 102 may comprise, or be formed of, a relatively softer material, such as, for example, steel and/or alloy steel, and the discharge valve seat insert 110 may comprise, or be formed of, one or more relatively harder materials, such as, for example, a carbide or a carbide-containing material, thereby to provide a more wear-resistant strike face. In at least some embodiments, the interference fit between the discharge valve seat insert 110 and the discharge valve seat carrier recess 108 may result in radially inward compressive forces on the discharge valve seat insert 110, via the discharge valve seat carrier recess 108, which, in turn, may extend the service life of the discharge valve seat insert 110. For example, the radially inward forces may be substantially uniform circumferentially around the discharge valve seat insert 110. This may reduce the wear rate, or substantially prevent degradation of, the discharge valve seat insert 110. In some embodiments, this may reduce the likelihood, delay, or substantially prevent, the discharge valve seat insert 110 from fracturing, for example, during operation of the fluid end 12. For example, when the discharge valve seat insert 110 comprises, or is formed of, a hard material, such as a carbide or a carbide-containing material, the compressive forces may function to reduce the likelihood, delay, or substantially prevent, the discharge valve seat insert 110 from fracturing. This contrasts with, for example, carbide valve seats positioned in a tapered aperture, which may result in relatively uneven compressive forces being exerted on the valve seat, which may lead to premature fracture or failure. In addition, such carbide valve seats may separate from the aperture in which they are positioned due to uneven compressive forces, which may often result in failure of the valve seat.

As shown in FIGS. 3, 5A, and 5B, the fluid end 12 further may include a discharge valve assembly retainer 116 connected to the fluid end block 20 and/or the discharge valve assembly 66. For example, in some embodiments, the discharge valve assembly retainer 116 may include the discharge manifold 38 connected to the fluid end block 20 and/or the discharge valve assembly 66, for example, via one or more fasteners, such as bolts, nuts, and/or studs. For example, the fluid end block 20 and/or the discharge manifold 38 may at least partially define a discharge valve seat assembly recess 118, and the discharge valve seat assembly 100 may be at least partially positioned in the discharge valve seat assembly recess 118. For example, the one or more fasteners may connect the discharge manifold 38 to the fluid end block 20, thereby retaining the discharge valve seat assembly 100 in position relative to the discharge port 30 of the fluid end block 20, for example, as shown in FIGS. 3, 5A, and 5B.

In some embodiments, the discharge valve seat assembly recess 118 may be at least partially defined by the discharge manifold 38. For example, as shown in FIGS. 5A and 5B, the discharge valve carrier body 104 may at least partially define a discharge valve outer carrier wall 120 at least partially positioned in the discharge valve seat assembly recess 118. The discharge valve outer carrier wall 120 may have a discharge valve carrier outer wall dimension DCWD, the discharge valve seat assembly recess 118 may have a discharge valve seat assembly recess wall dimension DVRWD, and the discharge valve assembly recess wall dimension DVRWD may be greater than the discharge valve carrier outer wall dimension DCWD, for example, such that the fit between the discharge valve seat assembly recess 118 and the discharge valve outer carrier wall 120 lacks a press fit.

In some embodiments, the discharge valve carrier body 104 may be at least partially positioned in the discharge valve seat assembly recess 118, which may not include a tapered wall. For example, the discharge valve outer carrier wall 120 may be at least partially positioned in the discharge valve seat assembly recess 118, and the discharge valve outer carrier wall 120 and the discharge valve seat assembly recess 118 may include mutually facing substantially cylindrical walls (e.g., substantially non-tapered walls and/or non-frustoconical surfaces). For example, in some embodiments, the discharge valve assembly retainer 116 may be connected to the fluid end block 20 and/or the discharge valve assembly 66, for example, via one or more fasteners, such as bolts, nuts, and/or studs, and such connection may prevent the need for a tapered engagement between the discharge valve seat assembly 100 and the fluid end block 20, thus potentially eliminating one or more of the above-noted potential issues associated with valve seats that are positioned in tapered apertures. For example, in some embodiments, no tapered apertures are machined into the fluid end block 20 for receipt of the discharge valve seat assembly 100, thus simplifying manufacturing and resulting in potential manufacturing efficiencies. Because there is no tapered fit, powerful tools for installing and/or removing the discharge valve seat assembly 100 may be unnecessary, thereby resulting in potential manufacturing and/or service efficiencies. This further may result in a reduced likelihood or prevention of damage to the discharge valve seat assembly 100 during installation and/or removal.

As shown in FIGS. 4B and 5B, in some embodiments, the suction valve member 68 (FIG. 4B) and/or the discharge valve member 96 (FIG. 5B) may include a valve body 122 and a valve seal 124 connected to the valve body 122. In some embodiments, the valve body 122 may define a longitudinal valve body axis V, an axial cross-section transverse to the valve body axis V, and a radial cross-section defined by a radial plane extending through the valve body 122 and coextensive with the valve body axis V. As shown in FIGS. 4B and 5B, the valve body 122 may include a valve head 126. The valve head 126 may have a substantially circular axial cross-section including a radially outer perimeter. The valve head 126 further may have a seal engaging surface 128 positioned to receive the valve seal 124. For example, the seal engaging surface 128 may be associated with the radially outer perimeter of the valve head 126. In some embodiments, one or more of the valve body 122 or the valve head 126 may comprise (or be formed of) one or more of a polymeric material, a composite material, or a corrosion-resistant alloy. The corrosion-resistant alloy may include any alloy comprising at least about 10.5% chromium.

As shown in FIGS. 4B and 5B, the valve head 126 further may have an exterior side 130 facing in a first direction along the valve body axis V, for example, substantially parallel to the valve body axis V. The valve head 126 also may have an interior side 132 facing in a second direction opposite the first direction, for example, along the valve body axis V (e.g., substantially parallel to the valve body axis V).

As shown in, for example, FIGS. 4A-5B, in some embodiments, the valve head 126 further may have a cavity 134 at least partially defining a cavity interior 136. The cavity interior 136 may extend between a cavity opening 138 and a cavity end 140, for example, as shown. According to some embodiments, this example configuration may result in reducing the mass of the suction valve member 68 and/or the discharge valve member 96 while substantially maintaining the strength of the valve head 126. In some embodiments, the cavity 134 may substantially concave and/or substantially dome-shaped. For example, the cavity interior 136 may be substantially concave and/or substantially dome-shaped. In some embodiments, the cavity end 140 may be located at a most axially remote extent of the cavity interior 136 (e.g., remote from the axial position of the cavity opening 138) and/or a cavity apex. As shown in FIGS. 4A-5B, the cavity opening 138 may face in the second direction along the valve body axis V. In some embodiments, the example configuration of the cavity 134 and/or other portions of the suction valve member 68 and/or the discharge valve member 96 may result in the respective valve member having one or more of: (1) a relatively reduced mass or weight as compared to other valve members; (2) a relatively higher strength-to-weight ratio as compared to other valve members; (3) a relatively higher fatigue-resistance as compared to other valve members, or (4) relatively more cost-efficient for manufacturing and/or shipping as compared to other valve members.

As shown in FIGS. 4B and 5B, for example, in some embodiments, the valve seal 124 may include a seat engaging surface 142 positioned to abut a seat surface 144 (e.g., a strike face) of the suction valve seat insert 82 or the discharge valve seat insert 110, thereby to prevent fluid flow through the respective suction valve assembly 64 or discharge valve assembly 66, in the closed condition. For example, the seat engaging surface 142 of the valve seal 124 and the seat surface 144 of the valve seat assembly may be configured to prevent fluid flow through the respective suction valve insert passage 86 or the discharge valve insert passage 114 in the respective valve seat assembly. The seat engaging surface 142 may be substantially annular and may extend in a direction oblique with respect to the valve body axis and, in some embodiments, the seat surface 144 of the valve seat assembly (e.g., the valve seat insert) may be substantially annular and may extend in a direction substantially parallel to the seat engaging surface 142, or within a range of acute angles of being substantially parallel.

As shown in FIGS. 4A-5B, in some embodiments, the valve body 122 further may include a plurality of guide legs 146 extending from the interior side 132 of the valve head 126. In some embodiments, each of the guide legs 146 may at least partially define a guide leg axis extending in the second direction, for example, substantially parallel to the second direction. The guide legs 146 and the respective suction valve insert passage 86 or the discharge valve insert passage 114 may at least partially define a flow channel through which fluid flows when the respective suction valve member 68 or discharge valve member 96 is in an open position. In some embodiments, the guide legs 146 may be positioned and configured to slide axially adjacent the respective suction port 28 or discharge port 30 (and/or the respective suction valve insert passage 86 or the discharge valve insert passage 114) as the respective suction valve member 68 or discharge valve member 96 reciprocates relative to the respective suction valve seat assembly 72 or discharge valve seat assembly 100 during opening and closing of the respective valve member relative to the respective valve seat assembly. The guide legs 146 may reduce the likelihood or prevent the respective valve member from becoming misaligned relative to the respective valve seat assembly.

Some embodiments may include four guide legs 146, for example, although other numbers of guide legs 146 are contemplated, and in embodiments having two or more guide legs 146, the guide legs 146 may arranged symmetrically or asymmetrically, and in some embodiments, the guide legs 146 may be axisymmetric with respect to the valve body axis V. For example, some embodiments may include three guide legs 146, and the guide legs 146 may be substantially equally circumferentially spaced.

As shown in FIGS. 4B and 5B, in some embodiments, the exterior side 130 of the valve head 68 may at least partially define a spring recess 148, and the suction valve assembly 64 and/or the discharge valve assembly 66 further may include a valve spring 150 (e.g., a valve biasing member) having an end at least partially positioned in the spring recess 148 (e.g., a spring coil positioned in the spring recess 148) and biasing the respective suction valve member 68 or discharge valve member 96 against the seat surface 144 of the respective the suction valve seat insert 82 or discharge valve seat insert 110. The spring recess 148 may be a substantially annular recess. As shown in FIG. 3, the suction valve assembly 64 and/or the discharge valve assembly 66 further may include a spring retainer 152 opposite the exterior side 130 of the valve head 126 and configured to provide a support for the valve spring 150, which may provide a biasing force against the respective suction valve member 68 or discharge valve member 96. In some embodiments, the spring retainer 152 may include retainer recess configured to receive therein an end of the valve spring 150 opposite the respective suction valve member 68 or discharge valve member 96. In some embodiments, the retainer recess may be a substantially annular recess, and the spring retainer 152 may include a spring centering boss 154 (e.g., as shown in FIG. 3) positioned and configured to substantially maintain alignment of the valve spring 150 relative to the respective suction valve member 68 or discharge valve member 96.

According to some embodiments, when the valve spring 150 is at least partially compressed, the respective suction valve member 68 or discharge valve member 96 moves away from the seat surface 144 to an open position, thereby opening the respective suction valve assembly 64 or discharge valve assembly 66 and allowing fluid to pass between the valve seal 124 and the seat surface 144 of the respective suction valve seat assembly 72 or discharge valve seat assembly 100, through the one or more guide legs 146 of the respective valve body 122, and through the respective suction valve assembly 64 or discharge valve assembly 66. In some embodiments, the valve spring 150 may be selected to provide a biasing force to close the respective suction valve assembly 64 or discharge valve assembly 66, for example, to maintain the seat engaging surface 124 of the valve seal 124 against the seat surface 144 of the respective suction valve seat assembly 72 or discharge valve seat assembly 100, until fluid pressure of fluid pressing against the respective suction valve member 68 or discharge valve member 96 reaches a sufficient magnitude (e.g., a predetermined magnitude) to overcome the biasing force, thereby allowing fluid to flow through the respective suction valve assembly 64 or discharge valve assembly 66, for example, until the fluid pressure drops below a minimum magnitude (e.g., a predetermined magnitude), below which the biasing force closes the respective suction valve assembly 64 or discharge valve assembly 66.

As shown in FIGS. 4B and 5B, in some embodiments, the suction valve member 68 and/or discharge valve member 96 further may include a protrusion 156 extending in the first direction from the exterior side 130 of the valve head 126. As shown in FIGS. 4B and 5B, for example, in some embodiments, an interior side 158 of the protrusion 156 may be substantially coexistent with the cavity end 140.

In some embodiments of the valve seal 124 may be annular and may have a radial cross-section that is substantially complimentary to the radial cross-section of a seal engaging surface of the respective suction valve member 68 and/or discharge valve member 96. For example, the radial cross-section of the valve seal 124 may include a valve body engaging surface that substantially follows the radial cross-section of the seal engaging surface of the respective suction valve member 68 or discharge valve member 96.

In some embodiments, components of the suction valve assembly 64 and/or the discharge valve assembly 66, such as the valve body 122 and the spring retainer 152, may include, or be formed of, metal, such as, for example, stainless steel and/or other similar metals. In some embodiments, the suction valve member 68 and/or or discharge valve member 96 may be formed via a forging process, resulting in a forged material component, which may be relatively stronger than a similar component having a comparable mass or weight, but formed by other processes, such as, for example, casting. In some embodiments, the suction valve member 68 and/or the discharge valve member 96 may be configured in a manner that facilitates formation via forging, for example, having draft angles that facilitate formation via forging. In at least some such embodiments, the suction valve member 68 and/or the discharge valve member 96 may be formed without the need for significant post-forging machining. In some embodiments, this may result in the suction valve member 68 and/or or discharge valve member 96 having one or more of: (1) a relatively reduced mass or weight as compared to other valve members; (2) a relatively higher strength-to-weight ratio as compared to other valve members; (3) a relatively higher fatigue-resistance as compared to other valve members, or (4) relatively more cost-efficient manufacturing and/or shipping as compared to other valve members. In some embodiments, metallic surfaces of the components may be surface-treated, heat-treated, carburized, nitride-treated, peened, and/or subjected to other surface-treating procedures to increase the durability and/or wear-resistance of the surfaces.

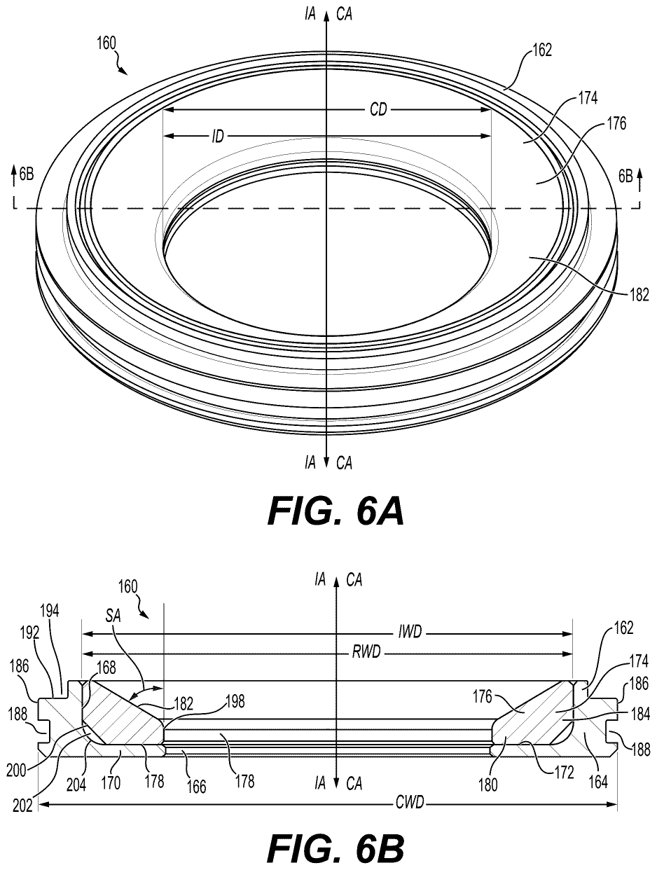

FIG. 6A is a schematic perspective view of an example valve seat assembly 160, for example, a suction valve seat assembly 72 and/or a discharge valve seat assembly 100, according to embodiments of the disclosure, and FIG. 6B is a schematic section view of the example valve seat assembly 160 shown in FIG. 6A, as viewed along section 6B-6B, according to embodiments of the disclosure. As shown, the valve seat assembly 160 may include a seat carrier 162, for example, a suction valve seat carrier 74 (see, e.g., FIGS. 4A and 4B) and/or a discharge valve seat carrier 102 (see, e.g., FIGS. 5A and 5B), including a carrier body 164, for example, a suction valve carrier body 76 and/or a discharge valve carrier body 104, at least partially defining a carrier passage 166, for example, a suction valve carrier passage 78 and/or a discharge valve carrier passage 106. The carrier passage 166 may have a carrier passage axis CA and a carrier passage dimension CD. The carrier body 164 may define a carrier body cross-section including a recess wall 168 extending substantially parallel to the carrier passage axis CA and at least partially defining a recess wall dimension RWD. In some embodiments, the carrier body 164 further may define a recess base 170 extending from the recess wall 168 and at least partially defining the carrier passage 166. In some embodiments, the recess wall 168 and the recess base 170 may at least partially define a seat carrier recess 172, for example, a suction valve seat carrier recess 80 and/or a discharge valve seat carrier recess 108.

As shown in FIGS. 6A and 6B, in some embodiments, the valve seat assembly 160 further may include a seat insert 174, for example, a suction valve seat insert 82 (see, e.g., FIGS. 4A and 4B) and/or a discharge valve seat insert 110 (see, e.g., FIGS. 5A and 5B), positioned in the seat carrier recess 172. The seat insert 174 may include an insert body 176, for example, a suction valve insert body 84 and/or a discharge valve insert body 112, at least partially defining an insert passage 178, for example, a suction valve 86 and/or a discharge valve insert passage 114, having an insert passage dimension ID and an insert passage axis IA substantially parallel to the carrier passage axis CA. As shown, in some embodiments, the insert body 176 may define an insert body cross-section including an insert base 180, for example, a suction valve insert base and/or a discharge valve insert base, positioned in the seat carrier recess 172 and contacting the recess base 170 of the seat carrier 162. The insert body cross-section of the insert body 176 further may define a strike face 182 opposite the insert base 180 and positioned to be intermittently contacted by a reciprocating valve member, for example, a suction valve member 68 or a discharge valve member 96. In some embodiments, the insert body cross-section of the insert body 176 further may define an insert outer wall 184 extending substantially parallel to the carrier passage axis CA and at least partially defining an insert outer wall dimension IWD. In some embodiments, the insert outer wall dimension IWD may be greater than the recess wall dimension RWD, thereby to provide an interference fit between the seat insert 174 and the seat carrier recess 172, such that the seat carrier recess 172 compresses the seat insert 174 and extends a service life of the seat insert 174. For example, in some embodiments, the interference fit between the seat insert 174 and the seat carrier recess 172 may range from about 0.001 inch to about 0.015 inches, from about 0.001 inch to about 0.011 inches, from about 0.001 inch to about 0.010 inches, from about 0.002 inches to about 0.015 inches, from about 0.002 inches to about 0.011 inches, or from about 0.002 inches to about 0.009 inches. Other interference fits are contemplated.

For example, in some embodiments, the seat carrier 162 may be substantially annular, and the seat insert 174 may be substantially annular, for example, as shown in FIG. 6A. Thus, in some embodiments, the recess wall dimension RWD may be the diameter of the of the recess wall 168, the insert outer wall dimension IWD may the diameter of the insert outer wall 184, the carrier passage dimension CD may be the diameter of the carrier passage 166, and/or the insert passage dimension ID may be the diameter of the insert passage 178. Other dimensions are contemplated, for example, radii or widths, for example, if the seat carrier 162, the seat insert 174, the carrier passage 166, and/or the insert passage 178 are not annular.

In some embodiments, as shown in FIG. 6B, the recess wall 168 at least partially defines a radially inward facing cylinder, for example, having a substantially constant recess wall dimension RWD (e.g., a substantially constant diameter). As shown, the recess base 170 may extend substantially perpendicular to the carrier passage axis CA. In some embodiments, the carrier body 164 may at least partially define an outer carrier wall 186 positioned in a recess of one or more fluid end components, for example, a recess at least partially defined by the fluid end block 20, the suction valve seat assembly recess 92 at least partially defined by the suction flange 90 (see, e.g., FIG. 4B), and/or the discharge valve seat assembly recess 118 at least partially defined by the discharge manifold 38 (see, e.g., FIG. 5B). In some embodiments, the recess of the one or more fluid end components (e.g., the recess wall dimension RWD) is greater than an outer carrier wall dimension CWD of the outer carrier wall 186 of the carrier body 164. For example, the fit between the recess of the one or more fluid end components and the outer carrier wall lacks a press fit. In some embodiments, the outer carrier wall 164 may at least partially define one or more radially outward facing cylindrical surfaces, for example, as shown in FIG. 6B, having corresponding substantially constant outer carrier wall dimension(s) CWD (e.g., substantially constant diameter(s)). In some embodiments, the outer carrier wall 186 of the carrier body 164 may lack tapering.

In some embodiments, as shown in FIG. 6B, the carrier body 164 further may at least partially define a seal recess 188 in the outer carrier wall 186, and the seal recess 188 may be positioned to receive an annular seal 190 (see, e.g., FIGS. 4B and 5B), such as an O-ring seal or other seal type. For example, the carrier body 164 further may at least partially define a carrier shoulder 192 in the outer carrier wall 186. In some embodiments, the carrier shoulder 192 may be configured to at least partially define a seal recess 194 positioned to receive an annular seal 196 (see, e.g., FIGS. 4B and 5B), such as an O-ring seal or other seal type.

As noted herein, in some embodiments, the carrier body 164 may comprise, or be formed of, a first material having a first material hardness, and the insert body 176 may comprise, or be formed of, a second material having a material hardness greater than the first material hardness. For example, in some embodiments, the first material may comprise steel and/or the second material may comprise carbide. The steel may include steel and any alloy steels. In some embodiments, the carbide may include cemented tungsten carbide. For example, the cemented tungsten carbide may a binder content ranging from about 5% by weight to about 20% by weight, from about 7% by weight to about 20% by weight, from about 10% by weight to about 20% by weight, from about 12% by weight to about 20% by weight, from about 10% by weight to about 17% by weight, from about 12% by weight to about 17% by weight, or from about 10% by weight to about 15% by weight. First and second materials comprising respective materials having respective similar material characteristics are contemplated.

As shown in FIG. 6B, in some embodiments, the insert outer wall 184 of the insert body 176 may extend substantially parallel to the insert passage axis IA, and the insert outer wall 184 may at least partially define a radially outward facing cylinder. For example, the insert outer wall dimension IWD may be substantially constant (e.g., the diameter of the insert outer wall 184 may be substantially constant). Thus, in some embodiments, the insert outer wall 184 may lack tapering.

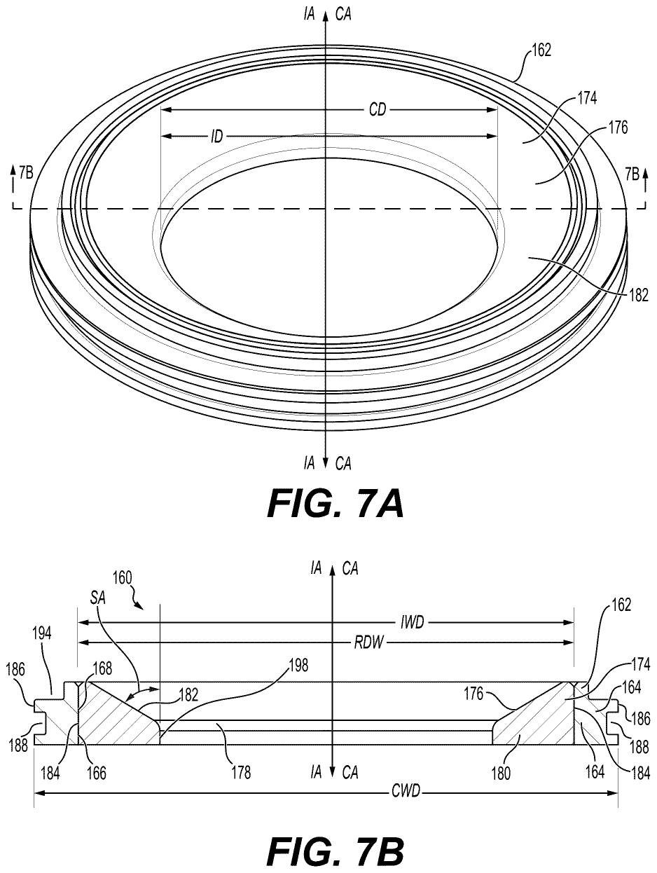

As shown in FIG. 6B, in some embodiments, the insert body 176 may define the insert base 180, which may extend substantially perpendicular to the insert passage axis IA. In some embodiments, the insert base 180 may be configured to contact (e.g., be at least partially supported by) the recess base 170 of the seat carrier 162. In some embodiments, the insert base 180 may not contact a recess base of the seat carrier 162, for example, if the seat carrier 162 and/or the seat carrier recess 172 does not include a recess base (see, e.g., FIG. 7B).

In some embodiments, for example, as shown in FIG. 6B, the strike face 182 of the seat insert 174 may extend at a strike face angle SA ranging from about 30 degrees to about 90 degrees relative to the insert passage axis IA, from about 30 degrees to about 80 degrees relative to the insert passage axis IA, from about 30 degrees to about 70 degrees relative to the insert passage axis IA, from about 30 degrees to about 60 degrees relative to the insert passage axis IA, from about 30 degrees to about 45 degrees relative to the insert passage axis IA, from about 40 degrees to about 90 degrees relative to the insert passage axis IA, from about 45 degrees to about 90 degrees relative to the insert passage axis IA, from about 50 degrees to about 90 degrees relative to the insert passage axis IA, from about 60 degrees to about 90 degrees relative to the insert passage axis IA, from about 45 degrees to about 70 degrees relative to the insert passage axis IA, or from about 30 degrees to about 80 degrees relative to the insert passage axis IA.

In some embodiments, the strike face 182 may present a strike surface sufficiently large to reduce or prevent contact between the interior side 132 of the valve head 126, as well as the interior side of the valve seal 124, for example, when the valve member (e.g., the suction valve member 68 or the discharge valve member 96) closes and contacts the strike face 182. For example, Applicant has recognized that for at least some valve assemblies including a hardened (e.g., a carbide) strike face, a portion of the interior side of the valve head may contact the valve seat at portion(s) not including the hardened surface. For example, for a valve seat that includes a non-hardened portion (e.g., steel) that receives the hardened portion of the strike face (e.g., formed of carbide), the interior side of the valve head, during closing, may directly contact the non-hardened portion in addition to the valve seal contacting the hardened portion of the strike face. This may, in turn, result in premature wear or failure of the valve seat, for example, the non-hardened portion, and in some instances, the interior side of the valve head. In some embodiments, the strike face 182 of the seat insert 174 may present a strike surface sufficiently large to reduce or prevent contact between the interior side 132 of the valve head 126, as well as the interior side of the valve seal 124, and the seat carrier 162, for example, when the valve member (e.g., the suction valve member 68 or the discharge valve member 96) closes and contacts the strike face 182. In at least some embodiments, this may reduce or prevent premature wear or failure of the seat carrier 162 and/or the interior side 132 of the valve head 126.

In some embodiments, for example as shown, the strike face 182 is substantially opposite the insert base 180, and the strike face 182 may extend substantially between the insert base 180 and the insert outer wall 184. For example, as shown in FIG. 6B, the strike face 182 may be connected to the insert base 180 at an inner portion 198, and the inner portion 198 may face radially inward and may at least partially define the insert passage 178. In some embodiments, the insert passage dimension ID may be substantially equal to or greater than the carrier passage dimension CD. As shown in FIG. 6B, for example, the insert body cross-section may further include an insert segment 200 extending between the insert outer wall 184 and the insert base 198. As shown, this may result in a cavity 202 (e.g., an annular cavity) between the seat insert 174 and the seat carrier recess 172 of the seat carrier 162. For example, the carrier body cross-section of the carrier body 164 may define a carrier segment 204 having a concave radius, as shown, and the insert segment 200 and the carrier segment 204 may at least partially define the cavity 202 therebetween.

FIG. 7A is a schematic perspective view of another example valve seat assembly 160, according to embodiments of the disclosure, and FIG. 7B is a schematic section view of the example valve seat assembly 160 shown in FIG. 7A, as viewed along section 7B-7B, according to embodiments of the disclosure. In some embodiments, the valve a seat assembly 160 may be substantially consistent with example the valve seat assemblies shown in FIGS. 2-6B. In some embodiments, however, as shown in FIGS. 7A and 7B, some valve seat assemblies 160 may include a seat carrier 162 having a seat carrier recess 172 that lacks a recess base (see, e.g., FIGS. 7A and 7B) and/or has a substantially truncated recess base, for example, as compared to the example seat carrier 162 and seat carrier recess 172 shown in FIGS. 6A and 6B. For example, in some embodiments consistent with the example valve seat assembly 160 shown in FIGS. 7A and 7B, the seat insert 174 and/or the insert base 180, although at least partially positioned in a seat carrier recess, is not supported by a recess base. Rather, in at least some embodiments, an interference fit between the insert outer wall 184 of the seat insert 174 and the recess wall 168 of the seat carrier 162 acts to support (e.g., solely supports) the seat insert 174 in the seat carrier recess, for example, with the recess wall 168 compressing the seat insert 174 an amount sufficient to solely support the seat insert 174 and/or secure the seat insert 174 relative to the seat carrier 162 and/or the remainder of the respective valve assembly. For example, the recess wall 168 may compress the seat carrier 162 radially inward, thereby to secure the seat insert 174 to the seat carrier 162, for example, in a manner at least similar to the embodiment shown in FIGS. 6A and 6B. In some such embodiments, the seat carrier 162, secured to the seat insert 174, may be connected and secured to the fluid end block 20, as described herein, thereby retaining the valve seat assembly 160 relative to the fluid end block 20.

A method to enhance reliability of a valve seat assembly 160 for a high-power pump 10 may include expanding a seat carrier recess 172 in a seat carrier 162 of the valve seat assembly 160 to provide an expanded seat carrier recess 172. The method further may include positioning a seat insert 174 of the valve seat assembly 160 in the expanded seat carrier recess 172, and contracting the seat carrier recess 172 around the seat insert 174, thereby to engage the seat insert 174 via the seat carrier recess 172, such that the seat carrier recess 172 compresses the seat insert 174 and extends a service life of the seat insert 174, for example, as described herein. For example, in some embodiments, the expanding of the seat carrier recess 172 may include heating the seat carrier 162, and in some embodiments, the contracting of the seat carrier recess 172 around the seat insert 174 may include allowing the seat carrier 162 to cool, for example, via actively cooling the seat carrier. In some embodiments of the method, the contracting of the seat carrier recess 172 around the seat insert 174 may result in compressing the seat insert 174 radially inward. In some embodiments of the method, the compressing of the seat insert 174 radially inward may be substantially equal circumferentially around the seat insert 174. For example, if the seat insert 174 is annular, and the seat carrier recess 172 is circular (e.g., having a substantially inward-facing cylindrical surface), as the seat carrier 162 cools and the seat carrier recess 172 contracts, the seat carrier recess 172 may radially contract, resulting in the seat carrier recess 172 applying radially inward-directed forces on the seat insert 174. In some embodiments, such forces may be substantially equal circumferentially around the seat carrier 174. In some embodiments, this may result in compressing the seat insert 174, thereby enhancing the resistance of the seat insert 174 and/or the valve seat assembly 160 to fracturing during assembly, fracturing during operation of the pump, fracturing during maintenance, and/or fracturing during removal of the seat insert 174 and/or the valve seat assembly 160. In some embodiments, this may result in enhancing the service life of the seat insert 174 and/or the valve seat assembly 160.

In some embodiments of the method, the contracting of the seat carrier recess 172 around the seat insert 174 may result in an interference fit between the seat insert 174 and the seat carrier recess, for example, as described herein, ranging from from about 0.001 inch to about 0.015 inches, from about 0.001 inch to about 0.011 inches, from about 0.001 inch to about 0.010 inches, from about 0.002 inches to about 0.015 inches, from about 0.002 inches to about 0.011 inches, or from about 0.002 inches to about 0.009 inches. Other interference fits are contemplated.

In some embodiments of the method, the seat carrier 162 may include a carrier body 164 comprising, or formed of, a first material having a first material hardness, and the seat insert 174 may include an insert body 176 comprising, or formed of, a second material having a material hardness greater than the first material hardness, for example, as described herein. For example, the first material may comprise, or be formed of, steel, and/or the second material may comprise, or be formed of, carbide. The steel may include steel and any alloy steels. In some embodiments, for example, the carbide may include cemented tungsten carbide comprising a binder content ranging from about 5% by weight to about 20% by weight, from about 7% by weight to about 20% by weight, from about 10% by weight to about 20% by weight, from about 12% by weight to about 20% by weight, from about 10% by weight to about 17% by weight, from about 12% by weight to about 17% by weight, or from about 10% by weight to about 15% by weight. Other carbide-containing materials are contemplated. First and second materials comprising respective materials having respective similar material characteristics are contemplated,

A method to retain a valve seat assembly 160 in a fluid end 12 of a high-power pump 10, thereby to enhance reliability of the valve seat assembly 160, may include providing a seat assembly recess (e.g., seat assembly recess 92 or 118) in one or more of a fluid end block 20 or a valve assembly retainer (e.g., valve assembly retainer 88 or 116). The seat assembly recess may have a recess wall dimension (e.g., recess wall dimension SVSWD or DVSWD). The method, in some embodiments, may further include positioning the valve seat assembly 160 in the seat assembly recess. The valve seat assembly 160 may have an outer wall dimension OCD less than the recess wall dimension. In some embodiments, the method also may include connecting the valve assembly retainer to the fluid end block 20, thereby to retain the valve seat assembly 160 relative to the fluid end block 20 and the valve assembly retainer, so as to extend a service life of the valve seat assembly 160, for example, as described herein.

In some embodiments of the method, the method further may include connecting a seat insert 174 of the valve seat assembly 160 to a seat carrier 162 of the valve seat assembly 160. The seat carrier 162 may at least partially define a seat carrier recess 172, and the seat insert 174 may be at least partially positioned in the seat carrier recess 172, for example, as described herein. In some embodiments, the connecting of the seat insert 174 to the seat carrier 162 may include providing an interference fit between the seat insert 174 and the seat carrier 162, for example, as described herein, such that the seat carrier recess 172 compresses the seat insert 174 and extends the service life of the seat insert 174. For example, providing an interference fit between the seat insert 174 and the seat carrier 162 may result in the seat carrier recess 172 compressing the seat insert 174 radially inward and extending the service life of the seat insert 174, for example, as described herein. In some embodiments of the method, providing the interference fit between the seat insert 174 and the seat carrier 162 may result in an interference fit between the seat insert 174 and the seat carrier recess 172 ranging from about 0.001 inch to about 0.015 inches, from about 0.001 inch to about 0.011 inches, from about 0.001 inch to about 0.010 inches, from about 0.002 inches to about 0.015 inches, from about 0.002 inches to about 0.011 inches, or from about 0.002 inches to about 0.009 inches. Other interference fits are contemplated.

In some embodiments of the method, the seat carrier 162 may include a carrier body 164 comprising, or formed of, a first material having a first material hardness, and the seat insert 174 may include an insert body 176 comprising, or formed of, a second material having a material hardness greater than the first material hardness, for example, as described herein. For example, the first material may comprise, or be formed of, steel, and/or the second material may comprise, or be formed of, carbide, for example, as described herein.

Having now described some illustrative embodiments of the disclosure, it should be apparent to those skilled in the art that the foregoing is merely illustrative and not limiting, having been presented by way of example only. Numerous modifications and other embodiments are within the scope of one of ordinary skill in the art and are contemplated as falling within the scope of the disclosure. In particular, although many of the examples presented herein involve specific combinations of method acts or system elements, it should be understood that those acts and those elements may be combined in other ways to accomplish the same objectives. Those skilled in the art should appreciate that the parameters and configurations described herein are exemplary and that actual parameters and/or configurations will depend on the specific application in which the systems, methods, and/or aspects or techniques of the disclosure are used. Those skilled in the art should also recognize or be able to ascertain, using no more than routine experimentation, equivalents to the specific embodiments of the disclosure. It is, therefore, to be understood that the embodiments described herein are presented by way of example only and that, within the scope of any appended claims and equivalents thereto, the disclosure may be practiced other than as specifically described.

This application claims priority to, and the benefit of U.S. Provisional Application No. 63/754,275, filed Feb. 5, 2025, titled “VALVE SEAT ASSEMBLIES, VALVE ASSEMBLIES, AND FLUID ENDS FOR HIGH POWER PUMPS AND RELATED METHODS,” the disclosure of which is incorporated herein by reference in its entirety.

Furthermore, the scope of the present disclosure shall be construed to cover various modifications, combinations, additions, alterations, etc., above and to the above-described embodiments, which shall be considered to be within the scope of this disclosure. Accordingly, various features and characteristics as discussed herein may be selectively interchanged and applied to other illustrated and non-illustrated embodiment, and numerous variations, modifications, and additions further may be made thereto without departing from the spirit and scope of the present disclosure as set forth in the appended claims.

1. A valve seat assembly to enhance reliability for a high-power pump, the valve seat assembly comprising:
(a) a seat carrier including a carrier body at least partially defining a carrier passage and comprising a first material having a first material hardness, the carrier body at least partially defining a seat carrier recess, the seat carrier recess at least partially defining a recess wall dimension; and
(b) a seat insert positioned in the seat carrier recess, the seat insert including an insert body comprising carbide having a second material hardness greater than the first material hardness, the insert body at least partially defining:
(i) an insert passage, and
(ii) an insert outer wall dimension, the insert outer wall dimension being greater than the recess wall dimension, thereby to provide an interference fit between the seat insert and the seat carrier recess, such that the seat carrier recess compresses the seat insert and extends a service life of the seat insert.

2. The valve seat assembly of claim 1, wherein:
the carrier passage has a carrier passage axis,
the carrier body defines a carrier body cross-section including a recess wall extending substantially parallel to the carrier passage axis, and
the recess wall at least partially defines a radially inward facing cylinder.

3. The valve seat assembly of claim 1, wherein:
the insert passage has an insert passage axis,
the insert body defines an insert body cross-section including an insert outer wall extending substantially parallel to the insert passage axis, and
the insert outer wall at least partially defines a radially outward facing cylinder.

4. The valve seat assembly of claim 1, wherein:
the carrier body at least partially defines an outer carrier wall positioned to be received in a recess at least partially defined by a fluid end component, and
one or more of:
(a) the carrier body further at least partially defines a seal recess in the outer carrier wall, the seal recess positioned to receive an annular seal, or
(b) the carrier body further at least partially defines a carrier shoulder in the outer carrier wall.

5. The valve seat assembly of claim 1, wherein one or more of:
(a) the carrier passage has a carrier passage axis, and the carrier body defines a carrier body cross-section including a recess base extending substantially perpendicular to the carrier passage axis, or
(b) the insert passage has an insert passage axis, and the insert body defines an insert base extending substantially perpendicular to the insert passage axis.

6. The valve seat assembly of claim 1, wherein the insert passage has an insert passage axis and the seat insert at least partially defines a strike face extending at a strike face angle, the strike face angle ranging from about 45 degrees to about 70 degrees relative to the insert passage axis.

7. The valve seat assembly of claim 1, wherein the insert body defines an insert body cross-section including:
an insert base positioned in the seat carrier recess,
a strike face opposite the insert base and positioned to be intermittently contacted by a reciprocating valve member, and
an insert outer wall extending substantially parallel to an insert passage axis of the insert passage, the strike face extending substantially between the insert base and the insert outer wall, and wherein one or more of:
(a) the strike face is connected to the insert base at an inner portion, the inner portion facing radially inward and at least partially defining the insert passage, or
(b) the insert body cross-section further includes an insert segment extending between the insert outer wall and the insert base.

8. The valve seat assembly of claim 1, wherein:
the insert body defines an insert body cross-section including an insert segment extending between an insert outer wall and an insert base,
the carrier body defines a carrier body cross-section including a carrier segment extending between a recess wall and a recess base, the carrier segment having a concave radius, and
the insert segment and the carrier segment at least partially define therebetween a cavity.

9. The valve seat assembly of claim 1, wherein the interference fit between the seat insert and the seat carrier recess ranges from about 0.002 inches to about 0.009 inches.

10. The valve seat assembly of claim 9, wherein one or more of:
the recess wall dimension is one of a radius or a diameter,
the insert outer wall dimension is one of a radius or a diameter,
the carrier passage dimension is one of a radius or a diameter, or
the insert passage dimension is one of a radius or a diameter.

11. The valve seat assembly of claim 1, wherein:
the first material comprises one or more of steel or alloy steel.

12. The valve seat assembly of claim 11, wherein:
the carbide includes cemented tungsten carbide comprising a binder content ranging from about 10% by weight to about 15% by weight.

13. A fluid end to enhance reliability of a valve seat for a high-power pump, the fluid end comprising:
(a) a fluid end block at least partially defining a fluid passage;
(b) a valve assembly connected to the fluid end block and positioned to at least partially control fluid flow through the fluid passage, and the valve assembly comprising:
(i) a valve member positioned to reciprocate, relative to a fluid passage of the high-power pump, between a closed position preventing fluid flow through the fluid passage and an open position allowing fluid flow through the fluid passage;
(ii) a biasing member connected to the valve member, the biasing member being positioned to bias the valve member in one of the closed position or the open position; and
(iii) a valve seat assembly comprising:
(aa) a seat carrier associated with the valve member, the seat carrier including a carrier body at least partially defining a carrier passage and comprising a first material having a first material hardness, the carrier body at least partially defining a seat carrier recess, the seat carrier recess at least partially defining a recess wall dimension; and
(bb) a seat insert positioned in the seat carrier recess, such that the valve member contacts the seat insert in the closed position and is spaced from the seat insert in the open position, the seat insert including an insert body comprising a second material having a material hardness greater than the first material hardness, the insert body at least partially defining (i) an insert passage and (ii) an insert outer wall dimension, the insert outer wall dimension being greater than the recess wall dimension, thereby to provide an interference fit between the seat insert and the seat carrier recess, such that the seat carrier recess compresses the seat insert and extends a service life of the seat insert; and
(c) a valve assembly retainer connected to one or more of the fluid end block or the valve assembly, one or more of the fluid end block or the valve assembly retainer at least partially defining a seat assembly recess, the valve seat assembly being at least partially positioned in the seat assembly recess.

14. The fluid end of claim 13, wherein the valve assembly comprises a discharge valve assembly, wherein the valve assembly retainer comprises a discharge manifold, and wherein the seat assembly recess is at least partially defined by the discharge manifold.

15. The fluid end of claim 14, wherein:
the fluid end block at least partially defines a seal recess, and
the fluid end further comprises a fluid seal positioned in the seal recess, the fluid seal compressed via the fluid end block and the seat carrier.

16. The fluid end of claim 13, wherein the valve assembly comprises a suction valve assembly, and the valve assembly retainer comprises a suction flange.

17. The fluid end of claim 13, wherein:
the seat carrier at least partially defines a seal recess, and
the fluid end further comprises a fluid seal positioned in the seal recess, the fluid seal being compressed via the fluid end block and the seat carrier, and wherein
the carrier body at least partially defines an outer carrier wall at least partially positioned in the seat assembly recess,
the outer carrier wall has an outer wall dimension,
the seat assembly recess has a recess wall dimension, and
the recess wall dimension is greater than the outer wall dimension.

18. A method to enhance reliability of a valve seat assembly for a high-power pump, the method comprising:
expanding a seat carrier recess in a seat carrier of the valve seat assembly to provide an expanded seat carrier recess;
positioning a seat insert of the valve seat assembly in the expanded seat carrier recess; and
contracting the seat carrier recess around the seat insert, thereby to engage the seat insert via the seat carrier recess, such that the seat carrier recess compresses the seat insert.

19. The method of claim 18, wherein the expanding of the seat carrier recess comprises heating the seat carrier, and wherein the contracting of the seat carrier recess around the seat insert comprises allowing the seat carrier to cool.

20. The method of claim 19, wherein the contracting of the seat carrier recess around the seat insert results in compressing the seat insert radially inward.

21. The method of claim 20, wherein the compressing of the seat insert radially inward is substantially equal circumferentially around the seat insert.

22. The method of claim 19, wherein:
the seat carrier comprises a carrier body comprising a first material having a first material hardness, and
the seat insert comprises an insert body comprising a second material having a material hardness greater than the first material hardness.

23. The method of claim 22, wherein the contracting of the seat carrier recess around the seat insert results in an interference fit between the seat insert and the seat carrier recess ranging from about 0.002 inches to about 0.009 inches.

24. The method of claim 22, wherein one or more of:
the first material comprises steel; or
the second material comprises carbide.

25. The method of claim 24, wherein the carbide includes cemented tungsten carbide comprising a binder content ranging from about 10% by weight to about 15% by weight.

26. A method to retain a valve seat assembly in a fluid end of a high-power pump, thereby to enhance reliability of the valve seat assembly, the method comprising:
positioning a valve seat assembly in a seat assembly recess in one or more of a fluid end block or a valve assembly retainer, the seat assembly recess having a recess wall dimension and the valve seat assembly having an outer wall dimension less than the recess wall dimension; and
connecting the valve assembly retainer to the fluid end block, thereby to retain the valve seat assembly relative to the fluid end block and the valve assembly retainer, so as to extend a service life of the valve seat assembly.

27. The method of claim 26, further comprising connecting a seat insert of the valve seat assembly to a seat carrier of the valve seat assembly, the seat carrier at least partially defining a seat carrier recess and the seat insert at least partially positioned in the seat carrier recess, and wherein the seat carrier comprises a first material having a first material hardness and the seat insert comprises a second material having a second material hardness greater than the first material hardness.

28. The method of claim 27, wherein the connecting of the seat insert to the seat carrier comprises providing an interference fit between the seat insert and the seat carrier, such that the seat carrier recess compresses the seat insert, and wherein one or more of:
the first material comprises steel, or
the second material comprises carbide.

29. The method of claim 27, wherein the connecting of the seat insert to the seat carrier comprises providing an interference fit between the seat insert and the seat carrier, such that the seat carrier recess compresses the seat insert radially inward, and wherein one or more of:
the first material comprises steel, or
the second material comprises carbide.

30. The method of claim 29, wherein the providing of the interference fit between the seat insert and the seat carrier results in an interference fit between the seat insert and the seat carrier recess ranging from about 0.002 inches to about 0.009 inches, and wherein the carbide includes cemented tungsten carbide comprising a binder content ranging from about 10% by weight to about 15% by weight.
